(19) United States
(12) Patent Application Publication
(10) Pub. No.: US 2026/0212526 A1
(43) Pub. Date: Jul. 23, 2026

(54) METHOD, APPARATUS AND SYSTEM FOR SUPPORTING EDGE COMPUTING-BASED PREDICTION OF COLLISION RISK BETWEEN SPECIFIC OBJECTS

(71) Applicant: HANWHA VISION CO., LTD., Seongnam-si (KR)

(72) Inventors: Nayeon KIM, Seongnam-si (KR); Hojung LEE, Seongnam-si (KR); HeeKyoung KIM, Seongnam-si (KR)

(73) Assignee: HANWHA VISION CO., LTD., Seongnam-si (KR)

(21) Appl. No.: 19/452,436

(22) Filed: Jan. 19, 2026

(30) Foreign Application Priority Data
Jan. 20, 2025 (KR) 10-2025-0008293
Dec. 22, 2025 (KR) 10-2025-0206486

(51) Int. Cl. G06T 7/70; G06T 7/20; G06T 11/23; G06T 11/60; G08G 7/00

(52) U.S. Cl. CPC G06T 7/70; G06T 7/20; G06T 11/23; G06T 11/60; G08G 7/00; G06T 2200/24; G06T 2207/10016; G06T 2207/20092; G06T 2210/12

(57) ABSTRACT

A method, apparatus and system for supporting edge computing-based prediction of collision risk between specific objects according to an example of the present disclosure are provided. In particular, the method may comprise acquiring a video of a specific space recorded by at least one recording module; checking a location of each object by detecting a plurality of objects in the acquired video based on at least one user-defined parameter value set through a platform server; checking a calibration parameter value corresponding to the location of each object; calculating a distance between each of the objects based on the calibration parameter value; and displaying the distance between each of the objects by overlaying within the acquired video.

### CROSS-REFERENCE TO RELATED APPLICATIONS

This application claims the priority of Korean Patent Application No. 10-2025-0008293 filed on Jan. 20, 2025, and 10-2025-0206486 filed on Dec. 22, 2025, in the Ministry of Intellectual Property of the Republic of Korea, the disclosure of which is incorporated herein by reference.

### BACKGROUND

### Field

The present disclosure relates to a method, apparatus and system for supporting edge computing-based prediction of collision risk between specific objects.

### Description of the Related Art

In certain spaces where workers and various mobile equipment operate simultaneously, such as logistics warehouses, manufacturing plants, and logistics centers, there are many cases where it is difficult to secure visibility and the movement route is complex due to the concentration of various facilities, materials, and machines. In such environments, there is always a collision risk between people and forklifts, vehicles, and equipment, and unexpected accidents can occur frequently due to blind spots, cognitive delays, and errors in determining the movement direction. In particular, immediate risk recognition and warning are very important because collisions between forklifts and workers occur in a short time in close proximity situations.

Conventionally, a black box or CCTV has been used to detect access by checking the surroundings. Proximity sensing equipment based on ultrasonic, radar, and wireless communication has been additionally installed. However, the method has problems in that it is difficult to check the object types or calculate the actual distance only with a simple image-capturing device, and short-range sensing equipment cannot reflect dynamic information such as the moving direction or relative velocity of the object, which may lead to excessive alarm notifications. In addition, the way of installing multiple sensors or transceivers for proximity detection has limitations in that it is difficult to easily apply in field environments due to the complex wiring and installation and the high cost burden. The server-based video analysis system also has a problem in that network latency makes it difficult to provide immediate notification in critical situations.

For this reason, there is a growing need for a technology that can recognize an object only with an image-capturing device without installing a complex sensor and accurately determine the collision risk by analyzing the relative position, moving direction, distance change and the like in real time. In addition, a real-time operating system is required that can set various conditions such as types of workers and vehicles, movement patterns, risk assessment criteria and the like to suit the actual working environment, and immediately reflect them on the image-capturing device while collectively managing them on the platform.

The background technology of the present disclosure was written to facilitate understanding of the present disclosure. It should not be understood that the matters described in the background of the disclosure exist as prior art.

### SUMMARY

There is a problem in that it is difficult to accurately recognize the state of various objects moving in a specific space with only an existing video-based verification device or a single proximity sensor, and excessive alarm notifications that do not sufficiently reflect the actual probability of collision, thereby simultaneously impairing work efficiency and safety.

In addition, the existing structure of installing multiple sensors or transceivers for risk assessment has problems in that installation and maintenance costs are too high, that it is not applicable to the field, and that in the server-centered analysis structure, real-time responsiveness is deteriorated due to network latency.

Accordingly, the inventors of the present disclosure recognized the necessity of a novel technology that enables efficient prediction of risky situations such as collision in a specific space by performing object detection, distance calculation, and movement direction analysis in the image-capturing device itself and providing immediate notification if necessary.

Accordingly, an object to be achieved by the present disclosure is to provide a method, apparatus and system for supporting edge computing-based prediction of collision risk between specific objects to effectively prevent collision accidents that may occur in a specific space by predicting whether there is a collision risk by calculating at least one predetermined distance between objects based on videos of the specific space recorded by at least one image-capturing device.

Objects of the present disclosure are not limited to the above-mentioned objects, and other objects not mentioned will be clearly understood by those skilled in the art from the description below.

In order to solve the above-described problems, a method for supporting edge computing-based prediction of collision risk between specific objects according to an example of the present disclosure is provided. The method may include acquiring a video of a specific space recorded by at least one recording module; checking a location of each object by detecting a plurality of objects in the acquired video based on at least one user-defined parameter value set through a platform server; checking a calibration parameter value corresponding to the location of each object; calculating a distance between the objects based on the calibration parameter value; and displaying the distance between the objects by overlaying within the acquired video.

According to a feature of the present disclosure, the at least one user-defined parameter value is input through a user interface provided by the platform server and may include at least one of a distance calculation target, a distance calculation condition, a distance calculation period, a threshold value, or an excluded area.

According to a feature of the present disclosure, checking the calibration parameter value may be mapping the calibration parameter value corresponding to the location of each object based on pre-stored calibration information.

According to a feature of the present disclosure, checking the calibration parameter value may include detecting a pre-specified reference object or marker in the acquired video and automatically calculating the calibration parameter value based on size information or location information of the reference object or marker.

According to a feature of the present disclosure, the method may further include providing an alarm notification in at least one method when at least one of the distances between the objects is equal to or less than a predetermined threshold value.

According to a feature of the present disclosure, the method may further include determining a risk level when the collision risk meets a predetermined risk condition.

According to a feature of the present disclosure, the method may further include providing an alarm notification in response to the determined risk level or suppressing providing the alarm notification when the collision risk is eliminated.

According to a feature of the present disclosure, when the collision risk is eliminated or providing an alarm notification is suppressed, a case includes a situation in which the presence or absence of a driver of a vehicle object or a movement state of the vehicle object among the plurality of objects satisfies a predetermined non-risk condition.

According to a feature of the present disclosure, the at least one method may include at least one of sound, video, text, vibration, or lighting, and may be set in different patterns for each risk level.

According to a feature of the present disclosure, the plurality of objects may be composed of at least one of person-to-person, person-to-vehicle, or vehicle-to vehicle.

According to a feature of the present disclosure, the displaying the distance between each object by overlaying within the acquired video may be visually displaying a bounding box containing each object and a straight distance between each object.

According to a feature of the present disclosure, the method may further include analyzing a movement path by tracking a time-series movement of each of the plurality of objects.

According to a feature of the present disclosure, the method may further include calculating a relative movement direction vector of each of the plurality of objects based on the time-series movement.

In order to solve the above-described problems, an apparatus for supporting edge computing-based prediction of collision risk between specific objects according to an example of the present disclosure is provided. The apparatus may include: a communication interface; at least one recording module; a memory; and a processor operably connected to the communication interface, the at least one recording module, and the memory, the processor being configured to acquire a video of a specific space recorded by at least one recording module, check a location of each object by detecting a plurality of objects in the acquired video based on at least one user-defined parameter value set through a platform server; check a calibration parameter value corresponding to the location of each object; calculate a distance between each of the objects based on the calibration parameter value, and display the distance between each object by overlaying within the acquired video.

In order to solve the above-described problems, a system for supporting edge computing-based prediction of collision risk between specific objects according to an example of the present disclosure is provided. The system may include at least one image-capturing device that acquires a video of a specific space, recorded by at least one recording module to calculate a distance between a plurality of objects and thereby determines whether there is a collision risk; a platform server communicatively connected to each image-capturing device to store and manage parameter values; and a user terminal connected to the platform server to provide a user interface, wherein each image-capturing device may be configured to check a location of each object by detecting the plurality of objects in the acquired video and calculate a distance between each of the objects based on calibration information, the platform server may transmit at least one user-defined parameter value to each image-capturing device, and the user terminal may be configured to display the video received from each image-capturing device or the result of the risk assessment through the platform.

Other detailed matters of the present disclosure are included in the detailed description and the drawings.

The present disclosure enables predicting the presence or absence of the collision risk by calculating at least one predetermined distance between objects based on a video of a specific space recorded by at least one image-capturing device, thereby effectively preventing a collision accident that may occur in that specific space.

The effects of the present disclosure are not limited to the above-mentioned effects, and other effects not mentioned will be clearly understood by those skilled in the art from the description below.

### BRIEF DESCRIPTION OF DRAWINGS

FIG. 1 is a schematic diagram illustrating a system for supporting edge computing-based prediction of collision risk between specific objects according to the present disclosure.

FIG. 2 is a block diagram illustrating a configuration of a platform server that provides services for supporting edge computing-based prediction of collision risk between specific objects according to the present disclosure.

FIG. 3 is a block diagram illustrating a configuration of an image-capturing device that performs services for supporting edge computing-based prediction of collision risk between specific objects according to the present disclosure.

FIG. 4 is a block diagram illustrating a configuration of a user terminal using services for supporting edge computing-based prediction of collision risk between specific objects according to the present disclosure.

FIG. 5 is a flowchart schematically illustrating a method for supporting edge computing-based prediction of collision risk between specific objects according to the present disclosure.

FIG. 6 is a diagram illustrating an example of a user interface implemented on a display module of a user terminal to predict a distance between two objects in a specific space according to a comparative example of the present disclosure.

FIG. 7 is a diagram illustrating an example of a user interface implemented on a display module of a user terminal to predict a distance between two objects in a specific space according to the present disclosure.

FIG. 8 is a diagram illustrating an example in which a bounding box containing two objects and a distance between two objects are overlaid and displayed on a video according to the present disclosure.

### DETAILED DESCRIPTION

Specific structural or stepwise descriptions of the concept of the present disclosure are merely illustrated for the purpose of describing the concept of the present disclosure. The concept of the present disclosure may be implemented in various forms and should not be construed as being limited to the examples described in the present disclosure or application.

The concept of the present disclosure may be modified in various ways and may have various forms. Therefore, specific examples will be illustrated in the drawings and will be described in detail in the present disclosure or application. However, this is not intended to limit the concept of the present disclosure to a specific disclosure form, and should be understood to include all changes, equivalents, or substitutes included in the spirit and technical scope of the present disclosure.

Terms such as first, second, etc., may be used to describe various components, but the components are not limited by the terms. The above terms are only for the purpose of distinguishing one component from another, and for example, without departing from the scope of rights according to the concept of the present disclosure, the first component may be referred to as a second component, and similarly, the second component may be referred to as a first component.

When a component is referred to as being “connected” or “coupled” to another component, it should be understood that the component may be directly connected or coupled to the other component, or there may be intervening components in between. On the other hand, when a component is referred to as being “directly connected” or “directly coupled” to another component, it should be understood that there are no intervening components in between. Other expressions that describe the relationship between components, that is, “between” and “immediately between” or “adjacent to” and “and directly adjacent to” should be interpreted as well.

In the present disclosure, the expressions “A or B”, “at least one of A or/and B”, or “one or more of A or/and B” may include all possible combinations of the items listed together. For example, “A or B”, “at least one of A and B”, or “at least one of A or B” may all refer to (1) including at least one A, (2) including at least one B, or (3) including both at least one A and at least one B.

The expressions “first”, “second”, “firstly”, or “secondly”, used in the present disclosure may describe various components, regardless of order and/or importance, and are used only to distinguish one component from another, but do not limit the components. For example, a first user device and a second user device may represent different user devices, regardless of order or importance. For example, without departing from the scope of the rights set forth in the present disclosure, a first component may be referred to as a second component, and similarly, a second component may be referred to as a first component.

The terms used in the present disclosure are used only to describe specific examples and may not be intended to limit the scope of other examples. The singular expression may include the plural expression unless the context clearly indicates otherwise. Terms used herein, including technical or scientific terms, may have the same meaning as commonly understood by a person of ordinary skill in the art described in the present disclosure.

Terms defined in general dictionaries among the terms used in the present disclosure may be interpreted as having the same or similar meaning as they have in the context of the relevant technology, and shall not be interpreted in an ideal or excessively formal sense unless explicitly defined in the present disclosure. In some cases, a term defined in a particular example cannot be interpreted to exclude other examples of the present disclosure.

The terms used in the present disclosure are used only to describe specific examples and not be intended to limit the present disclosure. Singular expressions include plural expressions unless the context clearly indicates otherwise. In the present disclosure, terms such as “including” or “having”, etc., are intended to indicate the existence of the features, numbers, steps, actions, components, parts, or combinations thereof disclosed in the specification. Accordingly, it may be understood that the terms are not intended to preclude the possibility that one or more other features, numbers, steps, actions, components, parts, or combinations thereof may exist or may be added.

Unless otherwise defined, all terms used here, including technical or scientific terms, have the same meaning as generally understood by those with ordinary knowledge in the technical field to which this disclosure pertains. Terms as defined in commonly used dictionaries should be construed as having a meaning consistent with the meaning in the context of the relevant art, and shall not be interpreted in an ideal or excessively formal sense unless explicitly defined in the present disclosure.

Each feature of various examples of the present disclosure may be partially or entirely coupled to or combined with each other. Accordingly, as may be fully understood by those skilled in the art, various technical connections and operations are possible, and each examples may be implemented independently of each other or can be implemented together in a related relationship.

In describing the present disclosure, descriptions of technical contents that are well known in the technical field to which the present disclosure pertains and are not directly related to the present disclosure may be omitted. This is to more clearly convey the gist of the present disclosure without blurring unnecessary descriptions.

For clarity of the interpretation of the present disclosure, terms used in the present disclosure will be defined below.

Hereinafter, a device referred to as a “platform server” may refer to one physically independent server according to the present disclosure, but is not limited thereto, and may be a single virtual machine, and is intended to cover all one module, program, or Docker operating in one virtual or physical machine.

Hereinafter, an example of the present disclosure will be described with reference to the accompanying drawing.

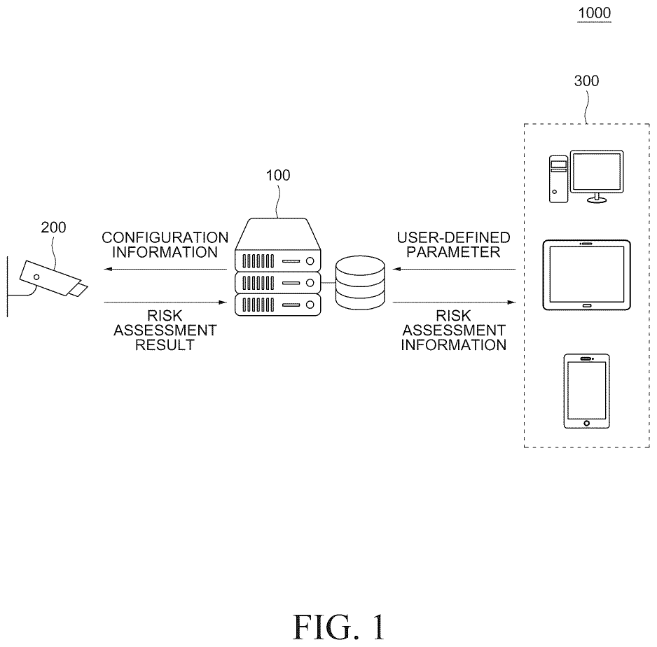

FIG. 1 is a schematic diagram illustrating a system for supporting edge computing-based prediction of collision risk between specific objects according to the present disclosure.

Referring to FIG. 1, a system that provides services for supporting edge computing-based prediction of collision risk between specific objects 1000 (hereinafter, referred to as a “service providing system”) according to the present disclosure may be configured to calculate a distance between a plurality of objects based on a recorded video of a specific space, determine whether there is a collision risk based on the relative positional relationship between the plurality of objects or whether there is a movement, and inform at least one user to enable a quick response when a dangerous situation is imminent or detected. The service providing system 1000 may include a platform server 100, an image-capturing device 200, and a user terminal 300.

The platform server 100 may be implemented in the form of a web server or an application server, and transmit and receive related configuration information so that the distance calculation and risk assessment process by the image-capturing device 200 may be smoothly performed according to a user's request. In this case, a prediction support service may be provided through a web page-based user interface or a separate platform application.

In addition, the platform server 100 may include one or more pre-trained artificial intelligence models as needed. These models can perform various functions such as classifying object types, updating adjustment values according to environmental changes, optimizing alarm policies and the like, and enable flexible implementation when the system is expanded in the future.

The platform server 100 may transmit at least one user-defined parameter value input from the user terminal 300 to the image-capturing device 200, and provide a video collected from the image-capturing device 200 or a risk assessment result to the user terminal 300 to transmit a real-time warning or information to the user. Here, the at least one user-defined parameter value is input through a user interface provided by the platform server 100 and may include at least one of a distance calculation target, a distance calculation condition, a distance calculation period, a threshold value, or an excluded area.

In addition, the platform server 100 may not only relay the distance information between objects received from the image-capturing device 200 and the risk assessment result, but also generate risk assessment information including risk levels, warning messages, notification patterns, summary data for logs, and the like based on the information, or reconfigure and provide the information in a format suitable for the user terminal 300. In this case, the platform server 100 may apply different threshold values, display rules, alarm notification policies, etc. for each site or user group and even under the same risk assessment result, generate different types of risk assessment information and transmit the risk assessment information to the user terminal.

Meanwhile, the image-capturing device 200 represents an edge computing device installed (or provided) in a specific space, and may acquire a video through a recording module, analyze the acquired video locally and then perform processing such as object detection, calibration-based distance calculation, time-series movement tracking, etc. In this case, the number of recording module provided in the image-capturing device 200 or one image-capturing device 200 may be at least one, and the number and type thereof are not limited. In the case in which there are a plurality of image-capturing devices 200, each image-capturing device 200 may be individually installed or provided in each area in a specific space.

For example, each of at least one image-capturing device 200 and/or at least one recording module may include at least one of a 2D camera, a 3D camera, a Time of Flight (ToF) camera, a light field camera, a stereo camera, an event camera, an infrared camera, a lidar sensor, and an array camera, through which a real-time video of a specific space may be acquired. In addition, it may include object detection and location calculation functions that detect objects such as people and vehicles in the acquired video and calculate the location of each object in the video. In addition, it may include a calibration-based distance calculation function that checks a calibration parameter value corresponding to an actual location of each object using pre-stored calibration information or reference marker information detected in a video, and calculates an actual distance between objects based on the calibration parameter value.

Further, the image-capturing device 200 may additionally include a time-series movement tracking function of analyzing a movement path by tracking a time-series movement pattern of each of a plurality of objects, and calculating a relative movement direction vector based on the same. It may also include functions for collision risk assessment that determines whether there is a collision risk by synthesizing information such as the calculated distance, movement direction, movement velocity, etc. and generates a risk assessment result at each level according to the degree of risk.

The image-capturing device 200 may transmit the calculated distance information and the risk assessment result to the platform server 100 to provide to the user terminal 300, and may be configured to output a warning signal on its own as necessary.

In addition, the user terminal 300 represents at least one or more terminal carried by a pre-registered user on the platform server 100 or installed in a specific space, to receive (or to use) a prediction support service provided by the service providing system 1000. Here, the user may include a worker who performs work in a specific space, a manager who monitors or manages the corresponding space, or an integrated supervisor who supervises the entire facility.

Each user terminal 300 may be provided with a prediction support service by executing a web page or a platform-based application provided by the platform server 100. The user may input at least one user-defined parameter value into the platform server 100, and the platform server 100 may transmit the input at least one user-defined parameter value to the image-capturing device 200 for application.

Further, the user terminal 300 may display, in real time, a risk assessment result provided via the platform server 100 from the image-capturing device 200 or risk assessment information (e.g., a risk level, a warning message, an alarm notification pattern, summary data, etc.) reconfigured and generated by the platform server 100. For example, the user terminal 300 carried by the worker may directly display the collision risk level and alarm notification, and the surrounding workers may also immediately check the same risk information through the user terminal 300 installed in a specific work-space. The alarm notification provided at this time may be effectively delivered to the user, including at least one of visual, auditory, and/or tactile manners.

The user terminal 300 may be a terminal directly carried by an operator, an administrator, and the like, but may also be a terminal installed in a specific space so that multiple workers or managers can all check it. For example, the worker may directly receive and check the collision risk alarm notification through the user terminal 300 they carry, or other workers in the vicinity may recognize and respond to the same risk information through the alarm notification displayed on the user terminal 300 installed in the worker's work area.

In addition, the user terminal 300 may output the alarm notification in at least one of visual, auditory, and/or tactile manners according to the alarm notification type included in the risk assessment information received from the platform server 100. For example, when an alarm notification is visually provided, visual effects such as a warning message, a color change, and an icon blinking may be output to a display module equipped in the corresponding user terminal 300 or a separate display device connected (linked) with the corresponding user terminal 300.

Each of the user terminal 300 described above may be one or more devices. Each device may be a computer, UMPC (Ultra Mobile PC), workstation, net-book, Personal Digital Assistants (PDAs), portable computer, web tablet, wireless phone, mobile phone, smart phone, pad, smart watch, wearable terminal, e-book reader, portable multimedia player (PMP), portable game console, navigation device, black box, digital camera, or other mobile communication terminal, etc. on which each user can install and execute a plurality of applications, without being limited thereto.

The service providing system 1000 is not limited to the configuration illustrated in FIG. 1, and may further include other devices (terminals, servers, etc.) or may be configured except for some configurations.

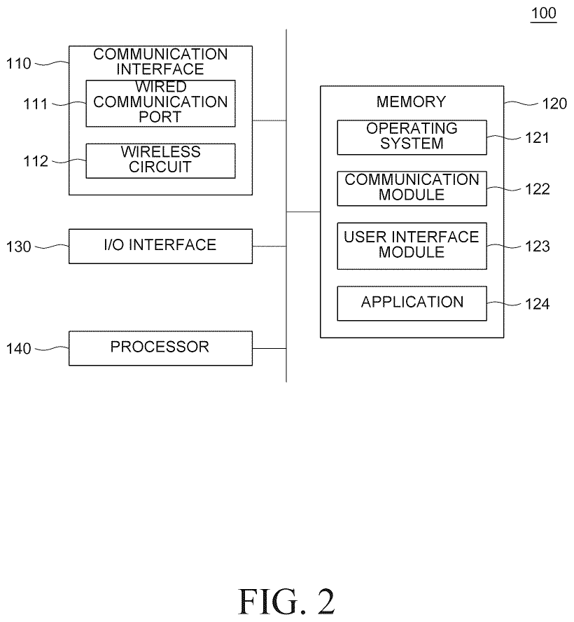

FIG. 2 is a block diagram illustrating a configuration of a platform server that provides services for supporting edge computing-based prediction of collision risk between specific objects according to the present disclosure.

Referring to FIG. 2, the platform server 100 may include a communication interface 110, a memory 120, an I/O interface 130, and a processor 140, and each component may communicate with each other through one or more communication buses or signal lines.

The platform server 100 may be configured to manage at least one user-defined parameter value based on communication with the image-capturing device 200 and the user terminal 300 and perform a relay/management function for applying the at least one user-defined parameter value and providing a service.

The communication interface 110 may be configured to transmit and receive data to and from the image-capturing device 200, the user terminal 300, as well as other external devices through a wired/wireless communication network.

Meanwhile, the communication interface 110 includes a wired communication port 111 and a wireless circuit 112, wherein the wired communication port 111 may include one or more wired interfaces, for example, Ethernet, a universal serial bus (USB), a Firewire, and the like. In addition, the wireless circuit 112 may transmit and receive data to and from an external device through an RF signal or an optical signal. In addition, wireless communication may use at least one of multiple communication standards, protocols and technologies, such as GSM, EDGE, CDMA, TDMA, Bluetooth, Wi-Fi, VoIP, Wi-MAX, or any other suitable communication protocol.

The memory 120 may store various data, instructions, and programs for the operation of the platform server 100. At least one user-defined parameter value (distance calculation target, distance calculation condition, threshold value, exclusion area, etc.), a list of image-capturing devices and apparatus information, user account information, etc. which are necessary to provide the prediction support service may also be stored in the memory 120.

In the present disclosure, memory 120 may include a volatile or nonvolatile recording medium capable of storing various data, instructions, and information. For example, the memory 120 may include at least one type of storage medium among flash memory type, hard disk type, multimedia card micro type, card type memory (for example, SD or XD memory, etc.), RAM, SRAM, ROM, EEPROM, PROM, network storage, cloud, and blockchain database.

In the present disclosure, the memory 120 may store the configuration of at least one of the operating system 121, the communication module 122, the user interface module 123, and one or more applications 124.

Operating system 121 (e.g. embedded operating systems such as LINUX, UNIX, MAC OS, WINDOWS, VxWorks, etc.) may include various software components and drivers for controlling and managing general system tasks (e.g., memory management, storage device control, power management, etc.), and may support communication between various hardware, firmware, and software components.

The communication module 122 may support communication with other devices through the communication interface 110. The communication module 122 may include various software components for processing data received by the wired communication port 111 or the wireless circuit 112 of the communication interface 110.

The user interface module 123 may receive a viewer's request or input from a keyboard, a touch screen, a microphone, etc. through the I/O interface 130, and provide a user interface on the display.

Application 124 may include programs or modules configured to be executed by one or more processors 140.

The I/O interface 130 may connect at least one of input/output devices (not shown) of the platform server 100, e.g., a display, a keyboard, a touch screen, and a microphone, to the user interface module 123. The I/O interface 130 may receive a user input (e.g., voice input, keyboard input, touch input, etc.) together with the user interface module 123 and process an instruction according to the received user input.

The processor 140 may be operatively connected to the communication interface 110, the memory 120, and the I/O interface 130 to control the overall operation of the platform server 100. The processor 140 may execute various instructions by running an application or a program stored in the memory 120.

For example, the processor 140 may be configured to receive and store at least one user-defined parameter value, such as a distance calculation target, a distance calculation condition, a distance calculation period, a threshold value, an excluded area, etc. input through the user terminal 300, and transmit and apply the at least one user-defined parameter value to the image-capturing device 200. Further, the processor 140 may receive, from the image-capturing device 200, the risk assessment result, the distance information between objects, the video, or the summary information, and forward the same to the user terminal 300 to display the real-time risk status. In addition, the processor 140 may generate a platform screen displayed on the user terminal 300 and process an instruction provided through the user interface.

As such, the platform server 100 is not configured to directly perform edge computing tasks such as object detection, calibration-based distance calculation, risk assessment, and the like performed on an image-capturing device, but configured to focus on platform operation functions for managing at least one user-defined parameter value, relaying information between devices, and providing services.

The processor 140 may correspond to a computing device such as a central processing unit (CPU) or an application processor (AP). In addition, the processor 140 may be implemented in the form of an integrated chip (IC) such as a system on chip (SoC) in which various computing devices are integrated. Alternatively, the processor 140 may include a module for calculating an artificial neural network model, such as a neural processing unit (NPU).

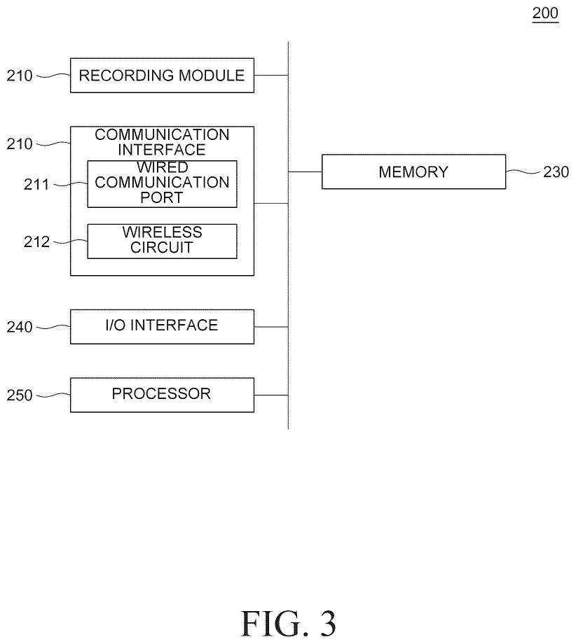

FIG. 3 is a block diagram illustrating a configuration of an image-capturing device that performs services for supporting edge computing-based prediction of collision risk between specific objects according to the present disclosure.

Referring to FIG. 3, an image-capturing device 200 includes a recording module 210, a communication interface 220, a memory 230, an I/O interface 240, and a processor 250, and each component may be connected to each other through one or more communication buses or signal lines.

The recording module 210 is configured to acquire video data by recording a specific space, and may include at least one of, for example, a 2D camera, a 3D camera, a Time of Flight (ToF) camera, a stereo camera, a LiDAR sensor, and an infrared camera.

The recording module 210 may continuously acquire video frames including various objects such as people, vehicles, and the like within a specific space and provide them to the processor 250.

The communication interface 220 is a component for the image-capturing device 200 to transmit and receive data to and from the platform server 100 and when necessary the user terminal 300, and may include a wired communication port 211 and a wireless circuit 212. The wired communication port 211 may include an interface such as Ethernet, USB, FireWire and the like, and the wireless circuit 212 may transmit and receive data based on various protocols such as GSM, EDGE, CDMA, Bluetooth, Wi-Fi, VoIP, Wi-MAX and the like using RF or optical signals. The image-capturing device 200 may receive at least one user-defined parameter value through the communication interface, and transmit the risk assessment result, the distance information between objects to the platform server 100, etc.

The memory 230 is a component that stores various data, instructions, and programs for the operation of the image-capturing device 200. For example, the memory 230 may store object detection model parameters, calibration data, distance calculation algorithm, risk assessment logic, time-series movement analysis algorithm and the like and may include at least one of various recording media such as flash memory, RAM, ROM, EEPROM, SD memory, network storage, etc.

The I/O interface 240 is a component for controlling devices such as warning lights, speakers, buzzers, vibration motors, etc. directly connected to the image-capturing device 200, and supports providing visual, audible, and tactile alarm notifications immediately without passing through a server when the image-capturing device 200 autonomously detects danger. The I/O interface 240 may also be connected to a status display LED or a check button.

The processor 250 is operatively connected to the recording module 210, the communication interface 220, the memory 230, and the I/O interface 240 to control the overall functions of the image-capturing device 200. The processor 250 may be implemented in the form of a CPU, microcontroller, AP, or System on Chip (SoC), and may include a dedicated calculation module such as NPU or DSP as necessary.

Specifically, the processor 250 may be configured to acquire a video of a specific space by controlling at least one recording module, check the location of each object by detecting a plurality of objects in the acquired video based on at least one user-defined parameter value set through the platform server, and then check a calibration parameter values corresponding to the locations of the respective objects. Thereafter, the processor 250 is configured to calculate actual distances between the objects based on the checked calibration parameter values and to display the calculated distance by overlaying within the acquired video.

The processor 250 may perform preprocessing processes such as noise removal, distortion correction, illumination change compensation and the like on the acquired video to normalize the video in a form suitable for object detection. For the preprocessed video, the processor 250 may execute an object detection algorithm or a training-based model stored in the memory 230 to detect objects such as people, vehicles, and equipment, and calculate feature information including a bounding box of each object, center point coordinates, and object types. At this time, the calculated image coordinates may be used as reference values for distance calculation and time-series analysis.

Further, the processor 250 can calculate calibration parameter values for converting the image coordinates of each object into real-world coordinates based on the calibration information pre-stored (e.g., camera installation altitude, installation angle, focal length, internal parameters, external parameters, etc.) or the detection results for the reference object/marker in the video. These calibration parameter values are used as a correction factor that enables accurate distance calculation despite differences in the installation environment.

Processor 250 may calculate actual distances between objects, an estimated size of the respective objects, movable areas of the respective objects, etc. using the calibration parameter values, and may track the time-series movements of the respective objects by analyzing location changes between multiple frames. Techniques such as Kalman Filter, optical flow, deep learning-based tracker, etc. may be applied to the tracking process.

In the present disclosure, the processor 250 may calculate a direction vector and a velocity vector by analyzing location changes of objects in a continuous frame. The direction vector is a vector connecting a current location and a previous location, and the velocity vector may be composed of a value quantitatively expressing the moving intensity of the object, including the magnitude of the direction vector. In addition, a relative direction vector and a relative velocity vector may be calculated to compare the movements between different objects, and based on this, it may be determined whether the objects are approaching or moving away from each other.

Furthermore, the processor 250 may calculate an approach vector or a collision prediction vector by combining the relative velocity vector and the distance variation. When the direction of the relative velocity vector matches or converges with the relative direction vector, the processor 250 may determine that the two objects are approaching each other and then predict a high risk level.

The processor 250 may determine the level of risk (e.g., normal, careful, dangerous, very dangerous) by applying a predefined risk assessment rule based on the calculated distance value, direction vector, velocity vector, approach vector, and movement pattern of the object. This risk level can be derived not only from simple distance comparisons but also from a combination of factors such as movement patterns, velocity changes, area intrusions, driver presence or stopped status of the vehicle object, and the like, and can be dynamically adjusted as the situation changes.

Depending on the determined risk level, the processor 250 may control a speaker, a warning light, a vibration motor, or a display device connected to the I/O interface 240 to immediately output an alarm notification based on visual, auditory, and tactile sense on-site. The type, intensity, and pattern of the alarm notification may be set differently according to the risk level.

Meanwhile, the processor 250 may transmit the distance information between objects, the object detection result, the risk assessment result, or the corresponding summary information to the platform server 100 through the communication interface 220. The platform server may display it on the user terminal 300 or use it for analysis, recording, or statistical processing in conjunction with the management system.

As such, the image-capturing device 200 may be implemented as a high-performance edge computing device that locally performs video acquisition, preprocessing, object detection, calibration-based distance calculation, time-series movement analysis, and risk assessment, rather than a simple video recording device, and may provide a rapid and stable collision risk prediction function without being affected by network latency or server processing velocity.

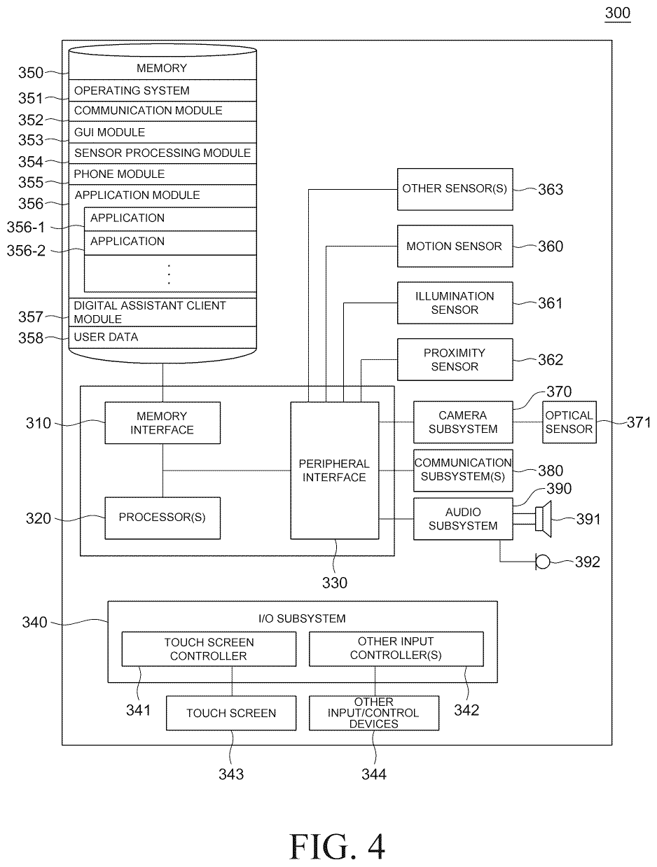

FIG. 4 is a block diagram illustrating a configuration of a user terminal using services for supporting edge computing-based prediction of collision risk between specific objects according to the present disclosure.

Hereinafter, for convenience of description, FIG. 4 will be described based on the user terminal 300, but if necessary, the image-capturing device 200 may be implemented on the same or similar hardware platform as the user terminal 300. For example, when a camera module is provided in the user terminal 300, the user terminal 300 may be configured to capture a specific space as the image-capturing device 200 and perform calculations for services for prediction support service.

Referring to FIG. 4, a user terminal 300 may include a memory interface 310, one or more processors 320 and a peripheral interface 330, an I/O subsystem 340, a memory 350, and a communication subsystem 380, each of which may be connected to each other via one or more communication buses or signal lines.

The memory interface 310 may be connected to the memory 350 to exchange data, instructions, and various types of information between the processor 320 and the memory 350. Here, the memory 350 may include at least one type of storage medium among flash memory type, hard disk type, multimedia card micro type, card type memory (for example, SD or XD memory, etc.), RAM, SRAM, ROM, EEPROM, PROM, network storage, cloud, and blockchain database.

In the present disclosure, memory 350 may store a web/app application or program for using a prediction support service. Further, the memory 350 may store data such as a video received from the platform server 100 or the image-capturing device 200, distance information between objects, a risk assessment result, at least one user-defined parameter value (distance calculation target, distance calculation condition, distance calculation period, threshold value, excluded area, etc.), a service usage history, etc.

In the present disclosure, the memory 350 may store at least one of an operating system 351, a communication module 352, a graphical user interface module (GUI) 353, a sensor processing module 354, a telephone module 355, and an application module 356. Specifically, the operating system 351 may include instructions for processing a basic system service and instructions for performing hardware tasks. Communication module 352 may communicate with at least one of another one or more devices, computer, and server. The graphic user interface module GUI 353 may process a graphic user interface. The sensor processing module 354 may execute sensor-related functions (e.g., processing voice input received through one or more microphones 392). The telephone module 355 may execute telephone-related functions. The application module 356 may perform various functions of a user application, such as electronic messaging, web browsing, media processing, browsing, imaging, and other process functions. In addition, the user terminal 300 may store one or more software applications 356-1, 356-2 associated with any one type of service (e.g., a service application) in the memory 350.

In the present disclosure, a memory 350 may store a digital assistant client module 357 (hereinafter, referred to as a DA client module), and accordingly, may store instructions and various user data 358 (e.g., user customized vocabulary data, preference data, and other data such as a user's electronic address book) for performing functions on the client side of the digital assistant.

Meanwhile, the DA client module 357 may acquire voice input, text input, touch input, and/or gesture input from the administrator (user) via various user interfaces (e.g., I/O subsystem 340) provided in the user terminal 300.

In addition, the DA client module 357 may output audio-visual and tactile types of data. For example, the DA client module 357 may output data including a combination of at least two of voice, sound, notification, text message, menu, graphic, video, animation, and vibration. In addition, the DA client module 357 may communicate with a digital assistant server (not shown) using the communication subsystem 380.

In the present disclosure, the DA client module 357 may collect additional information about the surroundings of the user terminal 300 from various sensors, subsystems, and peripheral devices to configure a context associated with the user input. For example, the DA client module 357 may infer a user's intention by providing context information together with a user input to the digital assistant server. Here, the context information that may be accompanied by a user input may include sensor information, for example, lighting, ambient noise, ambient temperature, images, video, and the like of the surroundings. For another example, the context information may include a physical state of the user terminal 300 (e.g., device orientation, device location, device temperature, power level, velocity, acceleration, movement pattern, cellular signal strength, etc.). As another example, the context information may include information related to the software status of the user terminal 300 (e.g., processes running on the user terminal 300, installed programs, past and current network activity, background services, error logs, resource usage, etc.).

In the present disclosure, memory 350 may include additional or deleted instructions. Furthermore, the user terminal 300 may include an additional configuration in addition to the configuration shown in FIG. 4, or may exclude some configurations.

The processor 320 may control the overall operation of the user terminal 300 and may execute various instructions for using a prediction support service provided by the platform server 100 by driving an application or a program stored in the memory 350.

The processor 320 may correspond to a computing device such as a central processing unit (CPU) or an application processor (AP). In addition, the processor 320 may be implemented in the form of an integrated chip (IC) such as a System on Chip (SoC) in which various computing devices for performing machine learning, such as a Neural Processing Unit (NPU), are integrated.

In the present disclosure, the processor 320 may provide various notifications, data, information, etc. through a user interface screen or may request them through the user interface screen.

The peripheral interface 330 may be connected to various sensors, subsystems, and peripheral devices provided in the user terminal 300 and provide data so that the user terminal 300 can perform various functions. Here, it may be understood that a function performed by the user terminal 300 is performed by the processor 320.

The peripheral interface 330 may be provided with data from the motion sensor 360, the lighting sensor (light sensor) 361, and the proximity sensor 362 so that the user terminal 300 may perform orientation, light, and proximity sensing functions. For another example, the peripheral interface 330 may receive data from other sensors 363 (positioning system-GPS receiver, temperature sensor, biometric sensor), which may allow the user terminal 300 to perform functions related to other sensors 363.

In the present disclosure, the user terminal 300 may include a camera subsystem 370 connected with the peripheral interface 330 and an optical sensor 371 connected thereto, such that the user terminal 300 may perform various recording functions such as photographing and video clip recording.

In the present disclosure, user terminal 300 may include communication subsystem 380 connected to peripheral interface 330. The communication subsystem 380 consists of one or more wired/wireless networks and may include various communication ports, radio frequency transceivers, and optical transceivers.

In the present disclosure, the user terminal 300 includes an audio subsystem 390 associated with the peripheral interface 330, and such audio subsystem 390 includes one or more speakers 391 and one or more microphones 392, such that the user terminal 300 may perform voice-operated functions, such as voice recognition, voice reproduction, digital recording, telephone functions, and the like.

In the present disclosure, the user terminal 300 may include an I/O subsystem 340 connected to the peripheral interface 330. For example, the I/O subsystem 340 may control the touch screen 343 included in the user terminal 300 through the touch screen controller 341.

For example, the touch screen controller 341 may detect a user's contact and movement or cessation of contact and movement by using any one of a plurality of touch sensing technologies such as capacitive, resistive, infrared, surface acoustic wave technology, proximity sensor array, etc. As another example, the I/O subsystem 340 may control other input/control devices 344 included in the user terminal 300 through other input controller(s) 342. As an example, the other input controller(s) 342 may control pointer devices such as one or more buttons, a rocker switch, a thumb-wheel, an infrared port, a USB port, and a stylus.

With this configuration, the user terminal 300 may display the risk assessment result received from the platform server 100 or the risk assessment information reconstructed and generated by the platform server 100 in real time. The risk assessment information may include a risk level, a warning message, a color change, an alarm notification pattern, a vibration, and the like, and may be provided to the user in a visual, audible, or tactile manner through a display, a speaker, a vibration motor, and the like provided in the user terminal 300.

The user terminal 300 may be a portable terminal such as a smartphone, a pad, a smart watch, etc., or may be configured to be fixedly installed in a work site so that multiple workers simultaneously recognize risk information.

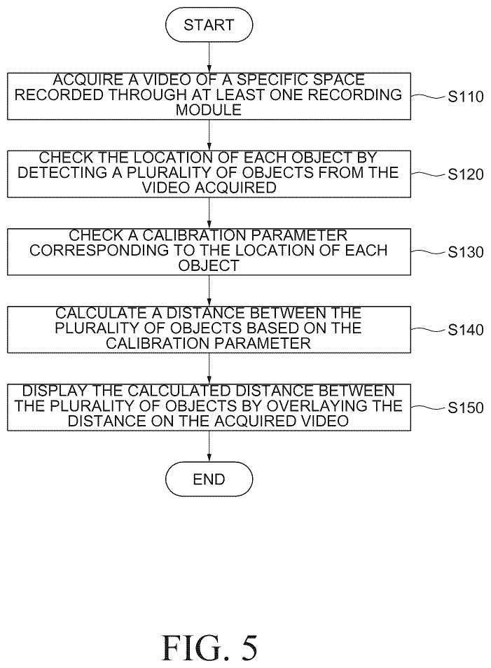

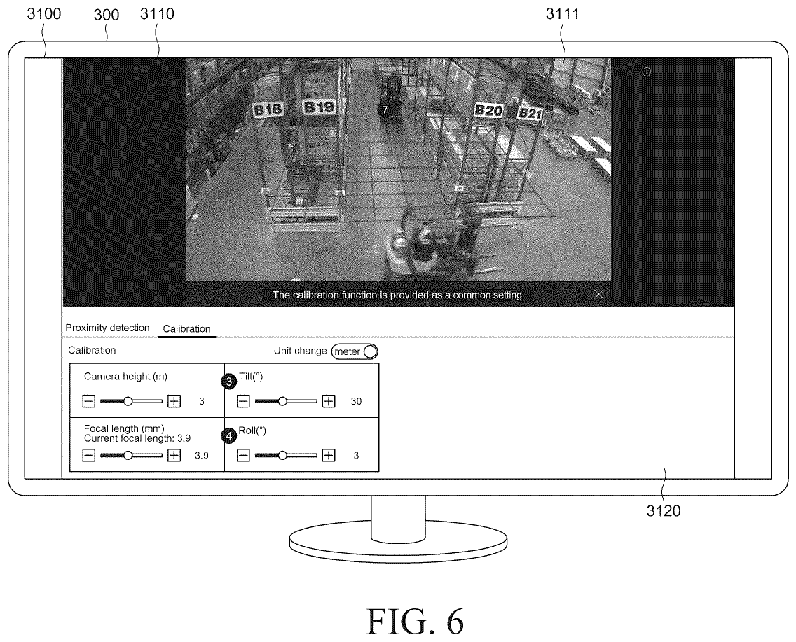

FIG. 5 is a flowchart schematically illustrating a method for supporting edge computing-based prediction of collision risk between specific objects according to the present disclosure. Hereinafter, an implementation example on an actual screen and a step-by-step processing process will be described in more detail with reference to FIGS. 6 to 8 while describing each step of FIG. 5.

Referring to FIG. 5, when a user requests to execute a prediction support service based on the platform server 100, the processor 250 acquires a video 3121 of a specific space recorded through at least one recording module 210 (S110).

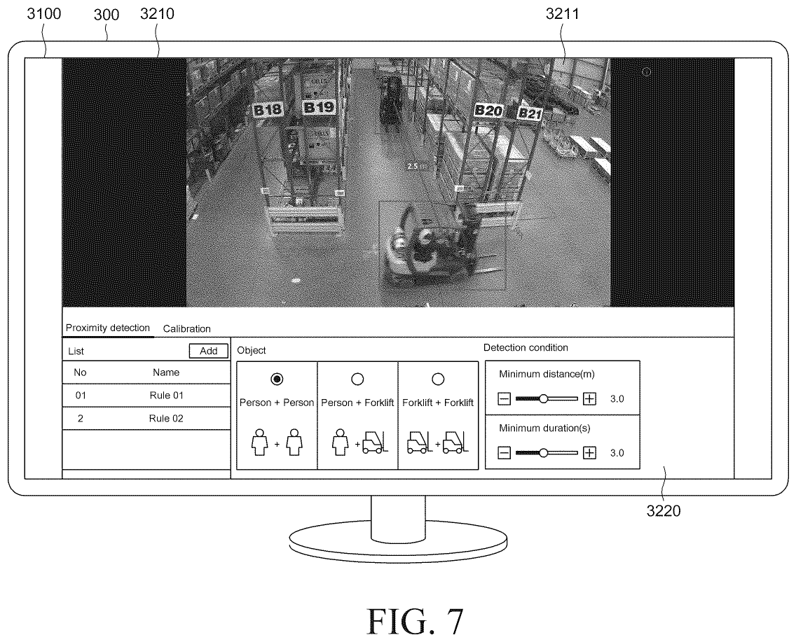

Specifically, as illustrated in FIG. 7, the processor 250 displays a video of the specific space 10 acquired through at least one recording module 210 in the first area 3210 on the display module 3100 of the user terminal 300. In this case, the displayed video 3211 may be a video of a space where people, vehicles, or facilities may exist simultaneously, such as a warehouse, a workplace, or a logistics space.

In the present disclosure, the processor 250 may perform preprocessing processes such as noise removal, distortion correction, and illumination correction on the acquired video to normalize the video state, making it suitable for object detection and distance calculation in a subsequent step. Next, the processor 250 checks the location of each object by detecting a plurality of objects from the video acquired in step S110 (S120).

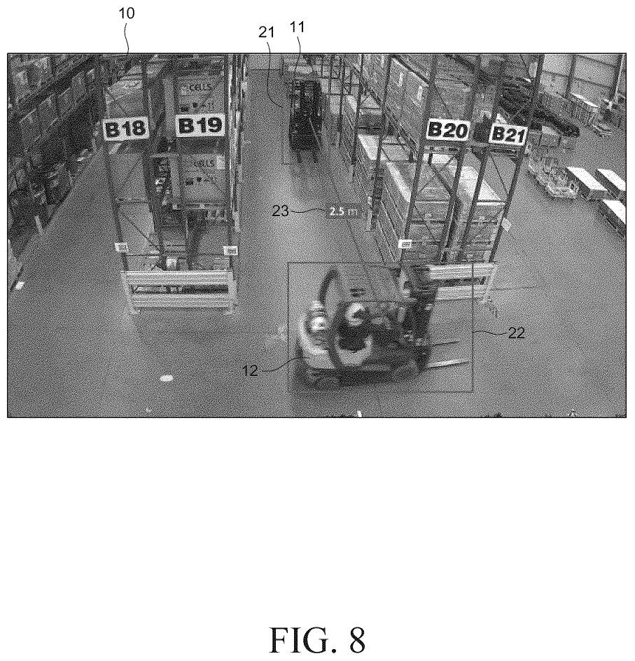

Specifically, the processor 250 may execute an object detection algorithm or a training-based model stored in a memory (not shown) to detect an object, such as a person, a vehicle, a forklift, a facility, etc. which exists in the video 3211. As shown in FIG. 8, each detected object may be displayed on a video in the form of bounding boxes 21 and 22, and location and attribute information such as center point coordinates of each object, object types, etc. may be calculated together.

In this case, the image coordinates of each object are used as reference information to subsequently calculate the distance and determine the collision risk.

Next, the processor 250 checks a calibration parameter value corresponding to the location of each object checked in step S120 based on at least two objects to be the targets for the distance calculation (S130).

Specifically, as illustrated in FIG. 7, a calibration tab may be formed in the second area 3220, and the user may input a distance calculation condition, such as an object type, a minimum distance, a detection duration, etc., which are the targets for distance calculation, based on the calibration tab.

Further, the processor 250 may determine a calibration parameter value for converting image coordinates of each object into actual spatial coordinates based on pre-stored calibration information such as a camera altitude, an installation angle, a focal length, internal and external parameters and the like corresponding to the installation environment of the image-capturing device 200, or a detection result for a reference object or marker in the video.

For example, the two objects may be one of a person and a person, a person and a vehicle, and a vehicle and a vehicle. However, this is only an example, and it may be set by adding materials, facilities, equipment, machines, etc. as a type of object or changing the configuration of the two objects.

Here, the user input may include at least one input operation performed through a display module (e.g., a touch screen) of the user terminal 300 according to a predetermined touch event, and for example, may be at least one of a touch, a double touch, a touch move (drag), a touch release, and a slide.

Meanwhile, referring to FIG. 6, a user interface implemented on the display module 3100 of the user terminal 300 according to a comparative example of the present disclosure may also display a video 3111 acquired from at least one recording module 210 in the first area 3110. However, in this case, a grid for distance measurement may be displayed in the corresponding video 3111, and the user must manually adjust that grid to match the actual distance value through the calibration tab formed in the second area 3120. For example, the user may estimate the distance between objects by setting one grid cell to correspond to 1 m.

However, in these comparative examples, there is a limitation that user manual settings are required, which may lead to setting errors, and resetting is needed when the installation environment changes. On the other hand, in the present disclosure, the distance between objects is automatically calculated based on the object detection result and pre-stored calibration information, enabling a more accurate and consistent distance calculation without user intervention.

Next, the processor 250 calculates a distance between the plurality of objects based on the calibration parameter value checked in step S130 (S140).

Specifically, the processor 250 may convert image coordinates of each object into actual spatial coordinates, and then calculate an actual distance between two objects to be targets for distance calculation. In this case, the distance calculation may be performed based on a single frame, or may be performed in consideration of a movement path and a location change of an object over multiple frames.

For example, as shown in FIG. 8, for the first vehicle 11 and the second vehicle 12, which are two objects existing in a specific space 10, a line segment 23 connecting the two objects may be generated, and the length of the line segment may be calculated as an actual distance value (e.g., 2.5 m).

Next, the processor 250 displays the calculated distance between the plurality of objects in step S140 by overlaying the distance on the acquired video (S150).

Specifically, as shown in FIG. 8, the processor 250, together with the bounding boxes 21 and 22, may provide distance information between objects by overlaying in the forms of text, lines, color marks, etc on the video. In this case, the color or display format of the distance information may be displayed differently according to a predetermined threshold value, and for example, may be displayed in green for a safe state, yellow for a caution state, and red for a risk state.

Meanwhile, although not shown in FIG. 5, the processor 250 continuously monitors the calculated distance value every predetermined period so that when the distance between objects decreases below a threshold value or is maintained for a predetermined time or longer, the processor 250 may be configured to provide an alarm notification through the image-capturing device 200 and/or the user terminal 300.

As described above, according to the present disclosure, the image-capturing device 200 may detect the plurality of objects based on a video of a specific space recorded by at least one image-capturing device including at least one recording module, and may predict the risk of collision may be predicted by automatically applying calibration parameter values corresponding to the location of each object and calculating the actual distance between the objects. In particular, more precise collision risk assessment is possible beyond simple distance comparison by analyzing the time-series movement of the object and considering the direction vector, the velocity vector, and the relative movement relationship. In addition, the collision risk assessment result may be processed in real time based on edge computing to provide an immediate alarm notification, and may be provided as various types of risk assessment information in conjunction with a platform server and a user terminal. Accordingly, the present disclosure provides a technical effect of preventing collision accidents that may occur in a work-space, a moving space, or a vehicle driving environment in advance and effectively improving the safety of workers and managers.

The examples of the present disclosure disclosed in the present specification and drawings are presented merely as specific examples to easily describe the technical details of the present disclosure and to help understand the present disclosure, and do not intend to limit the scope of the present disclosure. It will be apparent to those skilled in the art to which the present disclosure pertains that other modifications based on the technical idea of the present disclosure are possible in addition to the examples disclosed herein.

What is claimed is:

1. A method for supporting edge computing-based prediction of collision risk between specific objects, performed by an apparatus, comprising:
acquiring a video of a specific space recorded by at least one recording module;
checking a location of each object by detecting a plurality of objects in the acquired video based on at least one user-defined parameter value set through a platform server;
checking a calibration parameter value corresponding to the location of each object;
calculating a distance between the objects based on the calibration parameter value; and
displaying the distance between the objects by overlaying within the acquired video.

2. The method of claim 1, wherein the at least one user-defined parameter value is input through a user interface provided by the platform server, and
wherein the at least one user-defined parameter value includes at least one of a distance calculation target, a distance calculation condition, a distance calculation period, a threshold value, or an excluded area.

3. The method of claim 1, wherein checking the calibration parameter value comprises mapping the calibration parameter value corresponding to the location of each object based on pre-stored calibration information.

4. The method of claim 3, wherein checking the calibration parameter value comprises detecting a pre-specified reference object or marker in the acquired video and automatically calculating the calibration parameter value based on size information or location information of the reference object or marker.

5. The method of claim 1, further comprising:
providing an alarm notification in at least one method as at least one of the distances between the objects is equal to or less than a predetermined threshold value.

6. The method of claim 5, further comprising:
determining a risk level as the collision risk meets a predetermined risk condition.

7. The method of claim 6, further comprising:
providing the alarm notification in response to the determined risk level or suppressing the providing of the alarm notification upon elimination of the collision risk.

8. The method of claim 7, wherein, a case of the elimination of the collision risk or the suppression of the providing of the alarm notification includes satisfying a predetermined non-risk condition of the presence or absence of a driver of a vehicle object among the plurality of objects or the predetermined non-risk condition of a movement state of the vehicle object among the plurality of objects.

9. The method of claim 6, wherein the at least one method includes at least one of sound, video, text, vibration, or lighting, and is set in different patterns for each risk level.

10. The method of claim 1, wherein the plurality of objects include at least one of person-to-person, person-to-vehicle, or vehicle-to-vehicle.

11. The method of claim 1, wherein displaying the distance between the objects by overlaying within the acquired video comprises visually displaying a bounding box for each object together with a straight-line distance between the objects.

12. The method of claim 1, further comprising:
analyzing a movement path by tracking a time-series movement of each of the plurality of objects.

13. The method of claim 1, further comprising:
calculating a relative movement direction vector of each of the plurality of objects based on the time-series movement.

14. An apparatus for supporting edge computing-based prediction of collision risk between specific objects, comprising:
a communication interface;
at least one recording module;
a memory;
a processor operably connected to the communication interface, the at least one recording module, and the memory; and
the processor being configured to:
acquire a video of a specific space recorded by at least one recording module;
check a location of each object by detecting a plurality of objects in the acquired video based on at least one user-defined parameter value set through a platform server;
check a calibration parameter value corresponding to the location of each object;
calculate a distance between the objects based on the calibration parameter value; and
display the distance between each of the objects by overlaying within the acquired video.

15. A system for supporting edge computing-based prediction of collision risk between specific objects, comprising:
at least one image-capturing device that acquires a video of a specific space, recorded by at least one recording module to calculate a distance between a plurality of objects and thereby determines whether there is a collision risk;
a platform server communicatively connected to each image-capturing device to store and manage parameter values;
a user terminal connected to the platform server to provide a user interface;
each image-capturing device being configured to check a location of each object by detecting the plurality of objects in the acquired video and calculate a distance between each of the objects based on calibration information;
the platform server being configured to transmit at least one user-defined parameter value to each image-capturing device; and
the user terminal being configured to display the video received from each image-capturing device or a risk assessment result through the platform.
